(19) United States
(12) Patent Application Publication
(10) Pub. No.: US 2016/0259427 A1
(43) Pub. Date: Sep. 8, 2016

(54) Foldable Input Device

(71) Applicants: Wei ZHENG, Redmond, WA (US); Sang Hyun JEONG, Redmond, WA (US); Sheau Jiun YANG, Redmond, WA (US); Nicolas J.C. SCHMITT, Redmond, WA (US); Dhaval Jitendra JOSHI, Redmond, WA (US); Yujian PENG, Redmond, WA (US); MICROSOFT TECHNOLOGY LICENSING, LLC., Redmond, WA (US)

(72) Inventors: Wei Zheng, Shenzhen (CN); Sang Hyun Jeong, Beijing (CN); Sheau Jiun Yang, Beijing (CN); Nicolas J.C. Schmitt, Hong Kong (CN); Dhaval Jitendra Joshi, Shenzhen (CN); Yujian Peng, Shenzhen (CN)

(21) Appl. No.: 14/425,547

(22) PCT Filed: Oct. 30, 2014
(86) PCT No.: PCT/CN2014/089868

§ 371 Date: Mar. 3, 2015

(51) Int. Cl. G06F 3/02; G06F 3/023

(52) U.S. Cl. CPC G06F 3/0221; G06F 3/0231

(57) ABSTRACT

A foldable input device is described. In one or more implementations, an input device includes a first housing having a first collection of sensors configured to generate inputs responsive to user interaction and a second housing having a second collection of sensors configured to generate inputs responsive to user interaction. The input device also includes a wireless communication device configured to communicate the generated inputs to a computing device that are usable to initiate one or more operations of the computing device and a flexible hinge securing the first and second housings to each other and configured to permit rotational movement of the first and second housings in relation to each other.

### PRIORITY APPLICATION

This application claims benefit of priority of PCT Application Serial No. PCT/CN2014/089868 entitled “Foldable Input Device” filed Oct. 30, 2014, the content of which is incorporated by reference herein in its entirety.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIGS. 1A and 1B are illustrations of an environment in an example implementation showing a foldable input device.

FIG. 2 depicts an example implementation showing the input device of FIG. 1 as being folded.

FIG. 3 depicts an example implementation showing the input device of FIG. 1 as assuming a viewing configuration in relation to a mobile computing device.

FIG. 4 depicts an example implementation showing the input device of FIG. 1 as assuming a closed configuration in relation to a mobile computing device.

FIG. 5 illustrates an example system that includes an example computing device that is representative of one or more computing systems and/or devices that may interact with the various techniques described herein, as illustrated through inclusion of the input device.

### DETAILED DESCRIPTION

### Overview

Mobile computing devices have been developed to increase the functionality that is made available to users in a mobile setting. For example, a user may interact with a mobile phone, tablet computer, or other mobile computing device to communicate in telephone or teleconference calls, check email, surf the web, compose texts, interact with applications, listen to music, play games, and so on.

Because mobile computing devices are configured to be mobile, however, conventional techniques that are utilized to interact with the mobile computing device may be limited by the mobile configuration. For example, an onscreen keyboard may be useful to enter limited amounts of text but is not well suited for intensive data entry interactions. Further, display of the onscreen keyboard may consume significant amounts of an available display area of a display device of the mobile computing device, which may further limit usefulness of these conventional techniques. Conventional input techniques for mobile computing devices may be limited in a variety of ways, such as difficulty in text entry, consumption of valuable display area on a display device that may already be limited due to a mobile form factor, and so on.

A foldable input device is described. In one or more implementations, the input device includes a plurality of housing that are connected, one to another, using a flexible hinge. For example, the input device may be configured as a keyboard (e.g., QWERTY keyboard) having first and second collections of keys that are split across the first and second housings, i.e., the first housing includes the first collection and the second housing includes the second collection.

The flexible hinge, which may be made of a rubber-like material, may include one or more layers of fabric or other material secured to each other, may be folded to assume a closed configuration in which the first and second collections of keys are not accessible to a user and an open configuration in which the first and second housings are unfolded and the key collections are accessible to a user. In this way, a generally full size keyboard may support mobile transport and protect keys of the keyboard from damage. Additionally, a wireless communication device may be included to support connection with a variety of different operating systems. Further discussion of these and other examples may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

### Example Environment

FIGS. 1A and 1B are illustrations of an environment 100, 150 having different views of an input device 102. The input device 102 in this example is configured as a keyboard that is configured to provide inputs to initiate operations of a computing device, such as a mobile phone, tablet computer, portable gaming device, music player, desktop PC, set-top box, game console, wearable device, home appliance, and so on.

The input device 102 in this example is illustrated as including a wireless communication device 104 that is configured to communicate inputs from the input device 102 to a computing device. The wireless communication device 104 may also support wireless communication from the computing device to the input device 102. A variety of different wireless communication techniques may be employed by the wireless communication device 104, such as near field communication (NFC), Wi-Fi, Bluetooth®, cellular protocols (e.g., LTE), and so on.

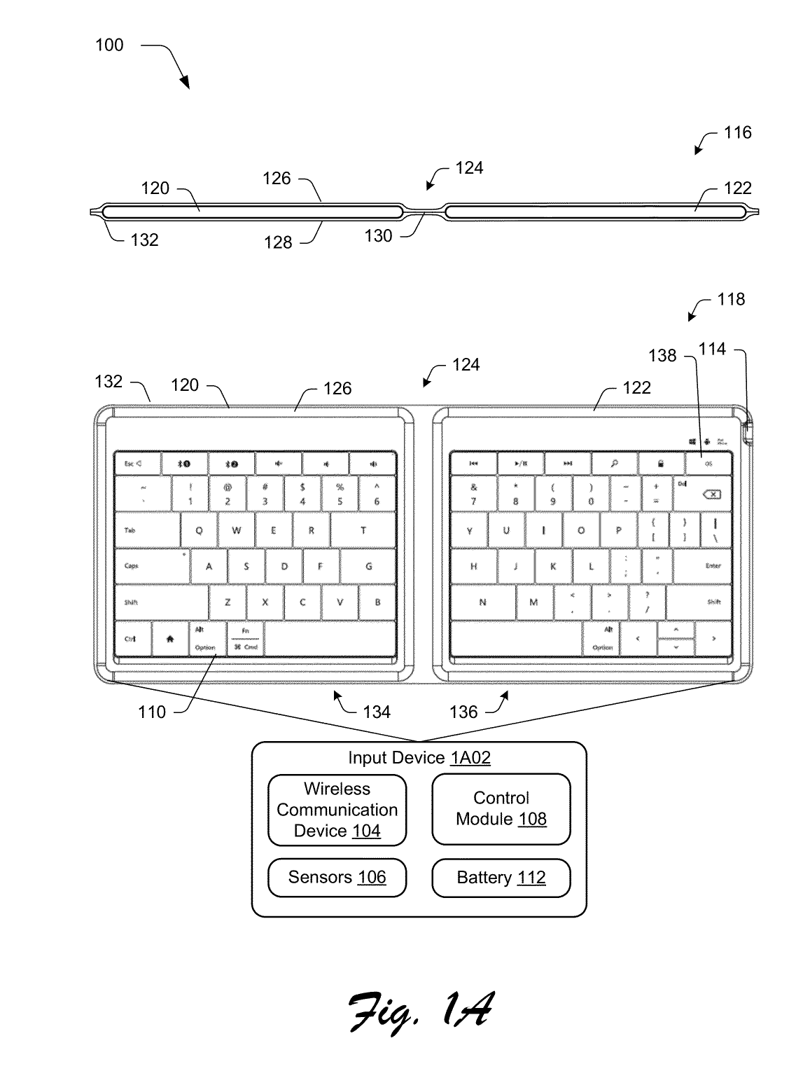

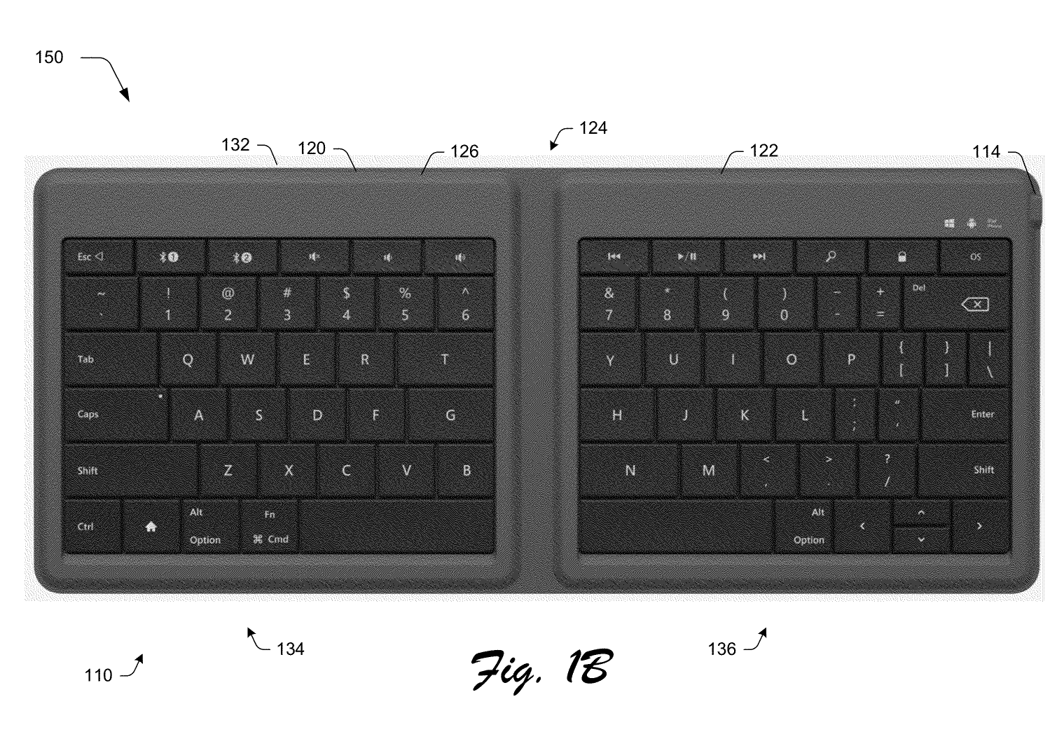

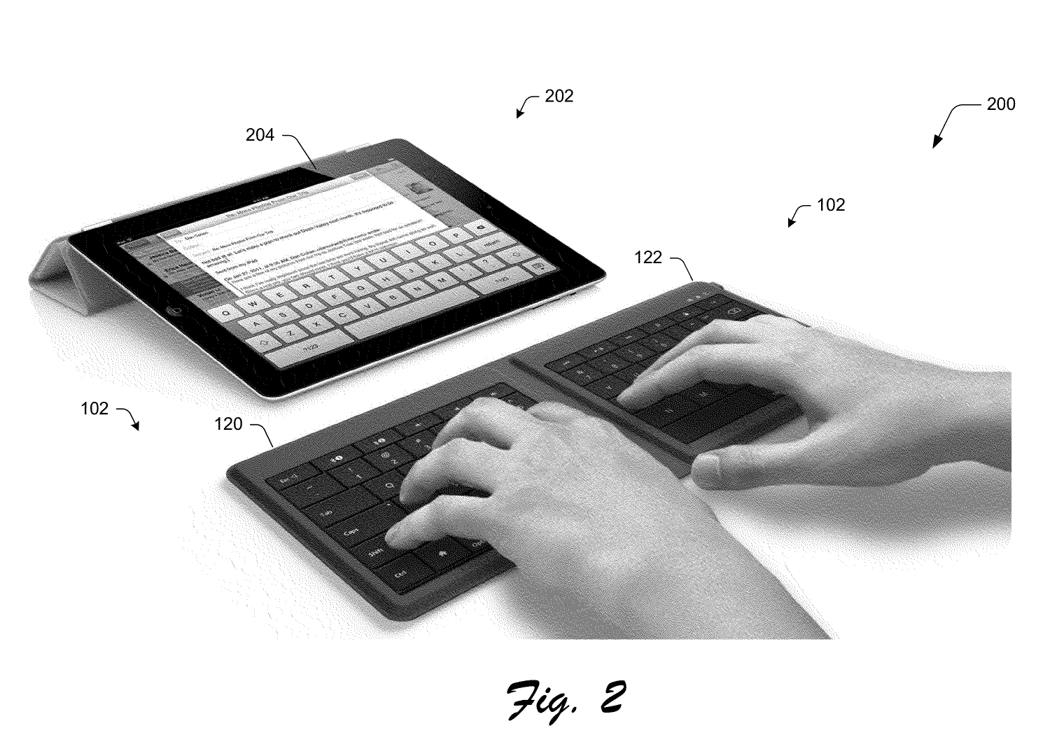

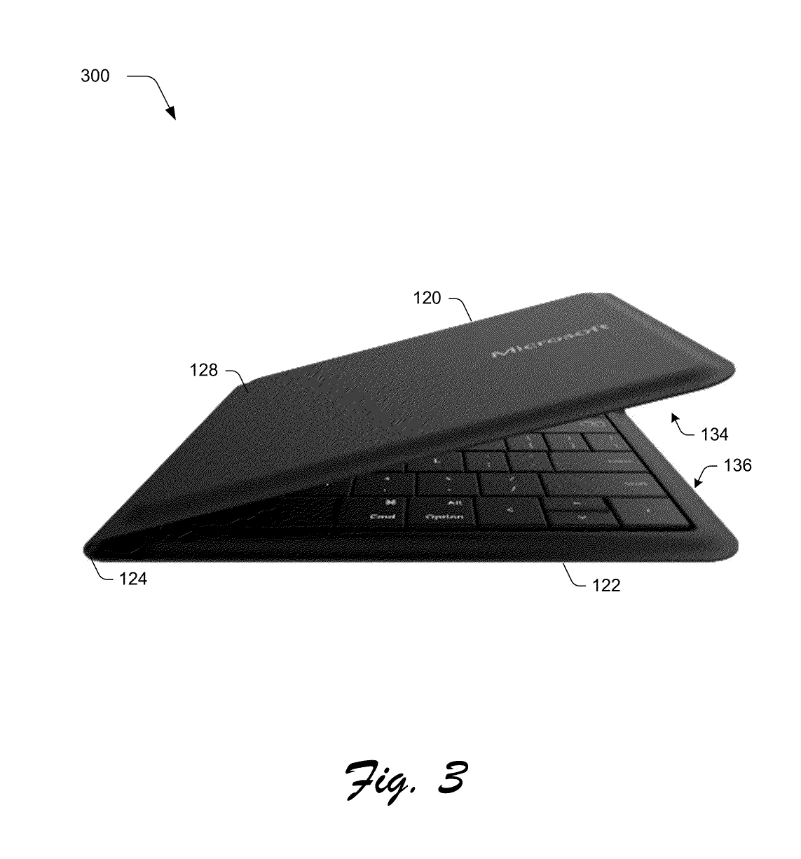

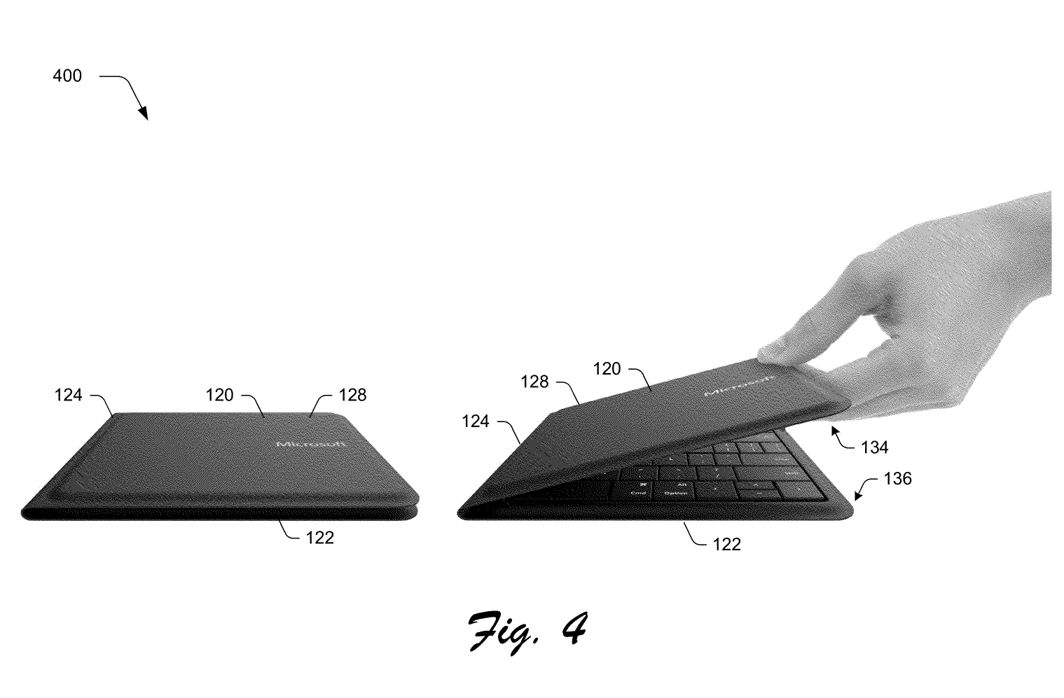

The input device 102 is also illustrated as including sensors 106, which may be utilized to support a variety of different functionality. The sensors 106, for instance, may be utilized to detect when the input device 102 is in different configurations. This may then be leveraged by a control module 108 to disable the wireless communication device 104 for configurations in which inputs are not to be received via sensors 110 (e.g., keys) are not accessible. Disabling the wireless communications device 104 and/or the electronics that detect keystrokes when the when the device is in a closed configuration may conserve battery 112 power. The battery 112 may be charged in a variety of ways, such as a plug-in connection 114 (e.g., micro USB®), induction, and so forth. For example, the sensors 106 may be configured to detect when the input device 102 is in the closed configuration as shown in FIG. 4 (e.g., through Hall-effect Sensors implanted in one or both of the housings or elsewhere on the device) and disable wireless communication of the wireless communication device 104. The reverse is also true in which the wireless communication device 104 may be woken up and powered on when the input device 102 is opened to perform wireless communication.

The sensors 110 (e.g., keys) are configured to support user interaction to generate inputs that are usable to initiate one or more operations of the computing device. The sensors 110 may be configured in a variety of ways, such as mechanical sensors (e.g., keys) as illustrated, pressure-sensitive keys (e.g., membrane switches using a force sensitive ink), capacitive sensors (e.g., to detect gestures, a trackpad), optical sensors, resistive sensors, ultrasonic sensors, and so forth. The sensors 110 may include any type of sensor that may detect user input. Haptic feedback components may be integrated with the sensors 110 or may be located proximate to sensors 110 to provide haptic feedback response to user input. For example, piezoelectric diaphragms may be used to provide haptic feedback response.

The input device 102 is shown in a cut-away view 116 and a top view 118 in the figure. As illustrated, the input device 102 includes a plurality of housings, which in this instance are first and second housing 120, 122 that are configured to rotate in relation to each other. Rotation may be implemented in a variety of different ways, such as through rotation of a pin. In the illustrated example, a flexible hinge 124 is employed to secure the first and second housings 122, 122 to each other and permit rotation in relation to each other. The flexible hinge 124 may also be implemented in a variety of ways. For example, the flexible hinge 124 may be formed from a rubber-like material that permits flexing of the material to support the rotational movement. Magnets and ferrous metals may be integrated into one or both of housings 120, 122 to facilitate closing of the input device 102. Placing magnet in both housings will encourage the two housings to assume a closed configuration as the magnets attract to each other. Further, the magnetic attraction will maintain the closed configuration so that the input device does not inadvertently fall open. In this way, the input device may stay protected from dust, dirt, and moisture because it is held closed during non-use. In alternative examples, one housing may include a magnet while the other housing may include a metal that is not necessarily a permanent magnet, but is nonetheless attracted to a magnet.

In the illustrated example, the flexible hinge 124 is formed from one or more layers of fabric, e.g., as a laminate structure. For example, the flexible hinge 124 may be formed from first and second outer layers 126, 128 of fabric. The first and second outer layers 126, 128 of fabric may be laminated together, along with a support layer disposed between (e.g., of Mylar), to form the flexible hinge 124 that secures the first and second housings 120, 122 to each other.

A conductor 130 may also be disposed through the flexible hinge 124 to support a communicative coupling between hardware components disposed in the first and second housings 120, 122, e.g., to permit communication of keys to control modules 108, a wireless communication device 104, and so on. In one or more implementations, the flexible hinge 124 may be configured to have a sufficient rigidity to support a maximum bend radius permitted by the conductor 130 without having the conductor break. Alternatively or additionally, housings 120, 122 may each have their own wireless communication device and battery. In this alternative, a conductor between the housings 120, 122 is not necessary.

In the illustrated example, the second outer layer 128 of fabric forms an outer surface of a rear (i.e., back) of the input device 102 that extends across a rear of both the first and second housings 120, 122 and the flexible hinge 124. In this way, a continuous outer surface may be provided thereby supporting improved user interaction and reduction in contamination that may enter an interior of the input device 102.

Likewise, the first outer layer 126 of fabric may form an outer surface of a front part of the input device 102 that includes the sensors 110, e.g., keys of the keyboard. The first outer layer 126, for instance, may form an outer layer of the sensors in a pressure-sensitive key configuration, may include an opening through which mechanical keys may be exposed as illustrated, and so on. The first outer layer 126 may thus form at least a part of an outer surface of the first and second housings 120, 122 and the flexible hinge 124. Thus, a continuous outer surface may also be provided for a front side of the input device 102 thereby supporting improved user interaction and reduction in contamination that may enter an interior of the input device 102. In one or more implementations, the first and second outer layers are secured to each other (e.g., laminated) along an outer perimeter of the input device 102 (e.g., portions of the first and second housings 120, 122 as well as the flexible hinge 124) which may also be used to support improved user interaction and reduction in contamination that may enter an interior of the input device 102.

The first and second housings 120, 122 are illustrated as including respective first and second collections 134, 136 of the sensors 110, e.g., keys of a keyboard. The example implementation is of a QWERTY keyboard but it should be apparent that a variety of other implementations are also contemplated. The keys of the keyboard in this example follow a generally row and column relationship. The flexible hinge 124 is disposed between the first and second collections 134, 136 to separate the columns from each other. A space bar is illustrated as being included in both the first and second collections 134, 136. Other separations and indeed additional flexible hinges are also contemplated, such as to support a tri-fold arrangement, a quadrant arrangement, and so forth.

The input device 102 includes sensor 138, which in the case depicted in FIG. 1 is a key. Sensor 138 is an operating system selector key that may select among multiple operating systems. Alternatively, multiple sensors or keys may each have individual associations with a different operating system. For example, input device 102 may have a key for “iOS,” “Android,” or “Windows.” An indicator light behind or proximate to the keys may indicate which operating system is selected. When the operating system selection function is implemented with one sensor or key, serial actuations of the sensor or key may serially select among the operating systems. An indicator light behind an operating system designation may light up as the selection switches from operating system to operating system. This feature advantageously permits the user to use input device 102 with multiple devices using multiple operating systems. The selection mechanism may be desirable because different operating systems are operable with different keyboard and input device configurations.

Rotation supported by the flexible hinge 124 may be utilized to support a variety of different configurations in which the input device 102 may be placed in relation to a mobile computing device. Examples of such configurations include an open configuration (e.g., to support typing via interaction with the sensors 110) as shown in FIG. 2 which may then be folded as shown in FIG. 3 to assume a closed configuration suitable for storage and transport as shown in FIG. 4.

FIG. 2 depicts an example implementation showing the input device 102 of FIG. 1 as assuming an open configuration 200 in relation to a mobile computing device 202. In this example, the mobile computing device 202 includes a housing configured as a slate that include a front surface having a display device 204.

In the open configuration, the sensors 110 (e.g., keys) of the first and second housings 120, 122 are accessible to a user. In this way, a user may view the display device 204, interact with touchscreen functionality of the display device 204, and interact with the sensors 110 of the first and second housings 120, 122 to provide inputs to the mobile computing device 202, e.g., by typing, use of gestures, and so forth.

FIGS. 3 and 4 depict example implementations 300, 400 showing folding of the input device of FIG. 2 and as assuming a closed configuration. In this example, the first and second housings 120, 122 are rotated in relation to each other through movement supported by the flexible hinge 124.

As illustrated, this causes surfaces of the first and second collections 134, 136 of sensors to be oriented toward each other in a closed configuration and thus disposed internally with a rear of the input device 102 that includes the second outer layer 128 of fabric to be exposed externally. In this way, the first and second collections 134, 136 may be protected from damage and environmental contaminants. A variety of other examples are also contemplated as previously described.

### Example System and Device

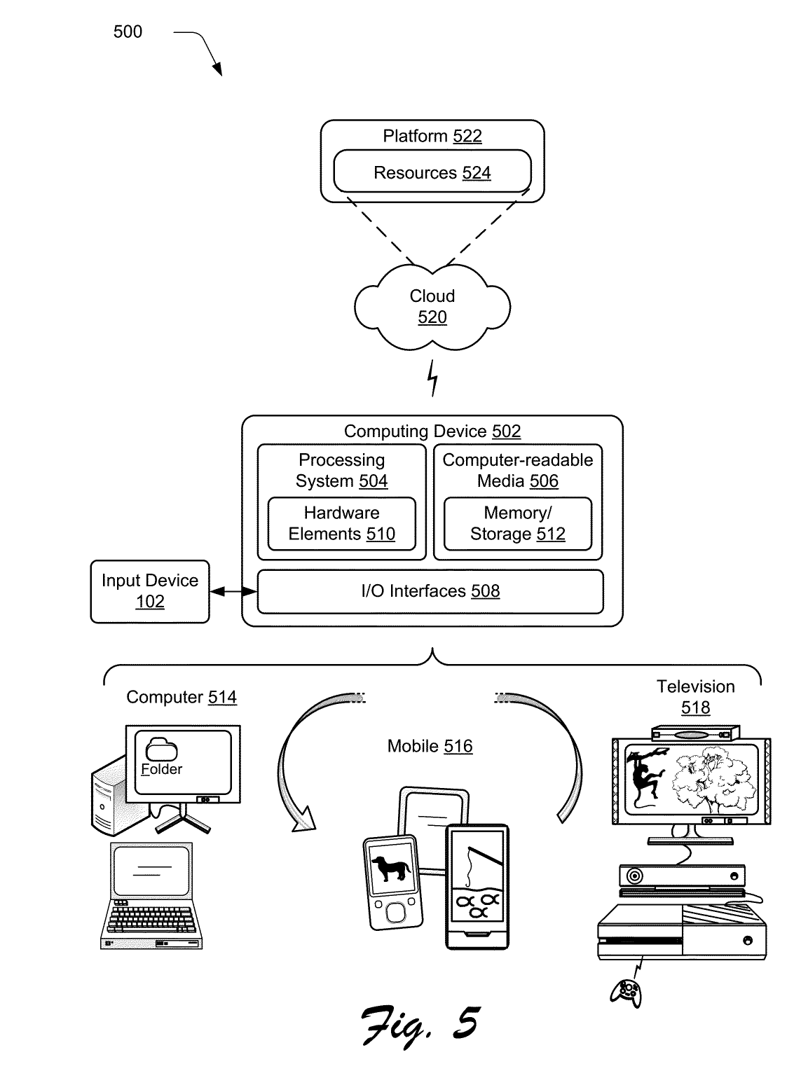

FIG. 5 illustrates an example system generally at 500 that includes an example computing device 502 that is representative of one or more computing systems and/or devices that may interact with the various techniques described herein, as illustrated through inclusion of the input device 102. The computing device 502 may be, for example, a server of a service provider, a device associated with a client (e.g., a client device), an on-chip system, and/or any other suitable computing device or computing system.

The example computing device 502 as illustrated includes a processing system 504, one or more computer-readable media 506, and one or more I/O interface 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware element 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 506 is illustrated as including memory/storage 512. The memory/storage 512 represents memory/storage capacity associated with one or more computer-readable media. The memory/storage component 512 may include volatile media (such as random access memory (RAM)) and/or nonvolatile media (such as read only memory (ROM), Flash memory, optical disks, magnetic disks, and so forth). The memory/storage component 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

Input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 502 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 510 and computer-readable media 506 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of a module that is executable by the computing device 502 as software may be achieved at least partially in hardware, e.g., through use of computer-readable storage media and/or hardware elements 510 of the processing system 504. The instructions and/or functions may be executable/operable by one or more articles of manufacture (for example, one or more computing devices 502 and/or processing systems 504) to implement techniques, modules, and examples described herein.

As further illustrated in FIG. 5, the example system 500 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 500, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 502 may assume a variety of different configurations, such as for computer 514, mobile 516, and television 518 uses. Each of these configurations includes devices that may have generally different constructs and capabilities, and thus the computing device 502 may be configured according to one or more of the different device classes. For instance, the computing device 502 may be implemented as the computer 514 class of a device that includes a personal computer, desktop computer, a multi-screen computer, laptop computer, netbook, and so on.

The computing device 502 may also be implemented as the mobile 516 class of device that includes mobile devices, such as a mobile phone, portable music player, portable gaming device, a tablet computer, a multi-screen computer, and so on. The computing device 502 may also be implemented as the television 518 class of device that includes devices having or connected to generally larger screens in casual viewing environments. These devices include televisions, set-top boxes, gaming consoles, and so on.

The techniques described herein may be supported by these various configurations of the computing device 502 and are not limited to the specific examples of the techniques described herein. This functionality may also be implemented all or in part through use of a distributed system, such as over a “cloud” 520 via a platform 522 as described below.

The cloud 520 includes and/or is representative of a platform 522 for resources 524. The platform 522 abstracts underlying functionality of hardware (e.g., servers) and software resources of the cloud 520. The resources 524 may include applications and/or data that can be utilized while computer processing is executed on servers that are remote from the computing device 502. Resources 524 can also include services provided over the Internet and/or through a subscriber network, such as a cellular or Wi-Fi network.

The platform 522 may abstract resources and functions to connect the computing device 502 with other computing devices. The platform 522 may also serve to abstract scaling of resources to provide a corresponding level of scale to encountered demand for the resources 524 that are implemented via the platform 522. Accordingly, in an interconnected device embodiment, implementation of functionality described herein may be distributed throughout the system 500. For example, the functionality may be implemented in part on the computing device 502 as well as via the platform 522 that abstracts the functionality of the cloud 520.

### Conclusion and Example Implementations

Example implementations described herein include, but are not limited to, one or any combinations of one or more of the following examples. In one or more examples, an input device includes a first housing having a first collection of sensors configured to generate inputs responsive to user interaction and a second housing having a second collection of sensors configured to generate inputs responsive to user interaction. The input device also includes a wireless communication device configured to communicate the generated inputs to a computing device that are usable to initiate one or more operations of the computing device and a flexible hinge securing the first and second housings to each other and configured to permit rotational movement of the first and second housings in relation to each other.

An input device as described alone or in combination with any of the above or below examples, wherein the flexible hinge is formed using one or more layers of fabric.

An input device as described alone or in combination with any of the above or below examples, wherein the one or more layers of fabric form at least a portion of an outer surface of the first and second housings.

An input device as described alone or in combination with any of the above or below examples, wherein the one or more layers of fabric include a plurality of layers of fabric that are laminated to each other.

An input device as described alone or in combination with any of the above or below examples, wherein the one or more layers of fabric include a plurality of layers of fabric that are secured to each other using an adhesive.

An input device as described alone or in combination with any of the above or below examples, wherein the one or more layers of fabric include a plurality of layers of fabric that are also secured to each other along at least a portion of outer edges of the first and second housings.

An input device as described alone or in combination with any of the above or below examples, wherein the flexible hinge includes one or more conductors that communicatively couple hardware components of the first and second housings to each other.

An input device as described alone or in combination with any of the above or below examples, wherein the flexible hinge has a rigidity that is sufficient to support a maximum bend radius of the conductors without causing breaking of the one or more conductors.

An input device as described alone or in combination with any of the above or below examples, wherein both the first and second housings include a spacebar.

An input device as described alone or in combination with any of the above or below examples, wherein the one or more sensors are configured as keys of a keyboard and the flexible hinge is disposed between columns of the keys.

An input device as described alone or in combination with any of the above or below examples, wherein the flexible hinge supports an open configuration of the first and second housings in which the one or more sensors are accessible for user interaction and a closed configuration of the first and second housings in which the one or more sensors are not accessible for user interaction.

An input device as described alone or in combination with any of the above or below examples, further comprising one or more sensors configured to detect that the first and second housings are in the closed configuration and responsive to this detection cause the wireless communication device to disable wireless communication.

An input device as described alone or in combination with any of the above or below examples, wherein the sensors are configured as mechanical keys, capacitive sensors, or membrane switches using a force sensitive ink.

In one or more examples, a keyboard includes a first housing having a first collection of keys configured to generate inputs responsive to user interaction and a second housing having a second collection of keys configured to generate inputs responsive to user interaction. The keyboard also includes a wireless communication device configured to communicate the generated inputs to a computing device that are usable to initiate one or more operations of the computing device and a flexible hinge securing the first and second housings to each other using a fabric that forms an outer surface that extends across both the first and second housings and permits rotation of the first and second housings in relation to each other.

A keyboard as described alone or in combination with any of the above or below examples, wherein the keys are configured as mechanical keys, capacitive sensors, or membrane switches using a force sensitive ink.

A keyboard as described alone or in combination with any of the above or below examples, wherein the flexible hinge supports an open configuration of the first and second housings in which the one or more keys are accessible for user interaction and a closed configuration of the first and second housings in which the one or more keys are not accessible for user interaction.

A keyboard as described alone or in combination with any of the above or below examples, further comprising one or more sensors configured to detect that the first and second housings are in the closed configuration and responsive to this detection cause the wireless communication device to disable wireless communication.

In one or more examples, a keyboard includes a first housing having a first collection of keys configured to generate inputs responsive to user interaction and a second housing having a second collection of keys configured to generate inputs responsive to user interaction. The keyboard also includes a wireless communication device configured to communicate the generated inputs to a computing device that are usable to initiate one or more operations of the computing device. The keyboard further includes a flexible hinge securing the first and second housings to each other that supports an open configuration of the first and second housings in which the one or more keys are accessible for user interaction and a closed configuration of the first and second housings in which the one or more keys are not accessible for user interaction.

A keyboard as described alone or in combination with any of the above or below examples, wherein the flexible hinge is formed using a fabric.

A keyboard as described alone or in combination with any of the above or below examples, wherein the fabric forms an outer surface that extends across both the first and second housings

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. An input device comprising:
a first housing having a first collection of sensors configured to generate inputs responsive to user interaction;
a second housing having a second collection of sensors configured to generate inputs responsive to user interaction;
a wireless communication device configured to communicate the generated inputs to a computing device that are usable to initiate one or more operations of the computing device; and
a flexible hinge securing the first and second housings to each other and configured to permit rotational movement of the first and second housings in relation to each other.

2. An input device as described in claim 1, wherein the flexible hinge is formed using one or more layers of fabric.

3. An input device as described in claim 2, wherein the one or more layers of fabric form at least a portion of an outer surface of the first and second housings.

4. An input device as described in claim 2, wherein the one or more layers of fabric include a plurality of layers of fabric that are laminated to each other.

5. An input device as described in claim 2, wherein the one or more layers of fabric include a plurality of layers of fabric that are secured to each other using an adhesive.

6. An input device as described in claim 2, wherein the one or more layers of fabric include a plurality of layers of fabric that are also secured to each other along at least a portion of outer edges of the first and second housings.

7. An input device as described in claim 1, wherein the flexible hinge includes one or more conductors that communicatively couple hardware components of the first and second housings to each other.

8. An input device as described in claim 7, wherein the flexible hinge has a rigidity that is sufficient to support a maximum bend radius of the conductors without causing breaking of the one or more conductors.

9. An input device as described in claim 1, wherein both the first and second housings include a spacebar.

10. An input device as described in claim 1, wherein the one or more sensors are configured as keys of a keyboard and the flexible hinge is disposed between columns of the keys.

11. An input device as described in claim 1, wherein the flexible hinge supports an open configuration of the first and second housings in which the one or more sensors are accessible for user interaction and a closed configuration of the first and second housings in which the one or more sensors are not accessible for user interaction.

12. An input device as described in claim 11, further comprising one or more sensors configured to detect that the first and second housings are in the closed configuration and responsive to this detection cause the wireless communication device to disable wireless communication.

13. An input device as described in claim 1, wherein the sensors are configured as mechanical keys, capacitive sensors, or membrane switches using a force sensitive ink.

14. A keyboard comprising:
a first housing having a first collection of keys configured to generate inputs responsive to user interaction;
a second housing having a second collection of keys configured to generate inputs responsive to user interaction;
a wireless communication device configured to communicate the generated inputs to a computing device that are usable to initiate one or more operations of the computing device; and
a flexible hinge securing the first and second housings to each other using a fabric that forms an outer surface that extends across both the first and second housings and permits rotation of the first and second housings in relation to each other.

15. A keyboard as described in claim 14, wherein the keys are configured as mechanical keys, capacitive sensors, or membrane switches using a force sensitive ink.

16. A keyboard as described in claim 14, wherein the flexible hinge supports an open configuration of the first and second housings in which the one or more keys are accessible for user interaction and a closed configuration of the first and second housings in which the one or more keys are not accessible for user interaction.

17. A keyboard as described in claim 16, further comprising one or more sensors configured to detect that the first and second housings are in the closed configuration and responsive to this detection cause the wireless communication device to disable wireless communication.

18. A keyboard comprising:
a first housing having a first collection of keys configured to generate inputs responsive to user interaction;
a second housing having a second collection of keys configured to generate inputs responsive to user interaction;
a wireless communication device configured to communicate the generated inputs to a computing device that are usable to initiate one or more operations of the computing device; and
a flexible hinge securing the first and second housings to each other that supports an open configuration of the first and second housings in which the one or more keys are accessible for user interaction and a closed configuration of the first and second housings in which the one or more keys are not accessible for user interaction.

19. A keyboard as described in claim 18, wherein the flexible hinge is formed using a fabric.

20. A keyboard as described in claim 19, wherein the fabric forms an outer surface that extends across both the first and second housings
